(19) United States
(12) Patent Application Publication
(10) Pub. No.: US 2014/0190942 A1
(43) Pub. Date: Jul. 10, 2014

(54) FORMING A LAYERED STRUCTURE

(71) Applicants: Andrew David Wescott, South Gloucestershire (GB); Jagjit Sindhu, South Goucestershire (GB)

(72) Inventors: Andrew David Wescott, South Gloucestershire (GB); Jagjit Sindhu, South Goucestershire (GB)

(73) Assignee: BAE SYSTEMS PLC, London (GB)

(21) Appl. No.: 14/237,665

(22) PCT Filed: Aug. 8, 2012
(86) PCT No.: PCT/GB2012/051926

§ 371 Date: Feb. 7, 2014

(30) Foreign Application Priority Data
Aug. 10, 2011 (GB) 1113756.9

(51) Int. Cl. B23K 26/34

(52) U.S. Cl. CPC B23K 26/345
USPC 219/76.1

(57) ABSTRACT

A method and apparatus for forming a layered structure. At least one raised area (202) is formed on a work piece (200), and a structure (302) is formed on the raised area using an Additive Layer Manufacturing (ALM) process.

The present invention relates to forming a layered structure.

Additive Layer Manufacture (ALM) is one of the advanced manufacturing methods that are becoming increasingly important in many applications, including aerospace and defence. ALM is a broad term used to describe a wide variety of technologies but generally involves the repeated layering of a desired material in order to create structural components. This addition of material might be to an existing structure in the form of a cladding, repair or the addition of fixings, or it may be the free form deposition of a material to form a new, independent structure. ALM processes are lean and agile production techniques, which have the capacity to significantly influence manufacturing.

ALM is a consolidation process that produces a functional complex part layer by layer without any moulds or dies. When using a laser, a laser beam melts a controlled amount of injected metallic powder on a base plate to deposit the first layer and on succeeding passes for the subsequent layers. As opposed to conventional machining processes, this computer-aided manufacturing (CAM) technology builds complete functional parts or features on an existing component by adding instead of removing material.

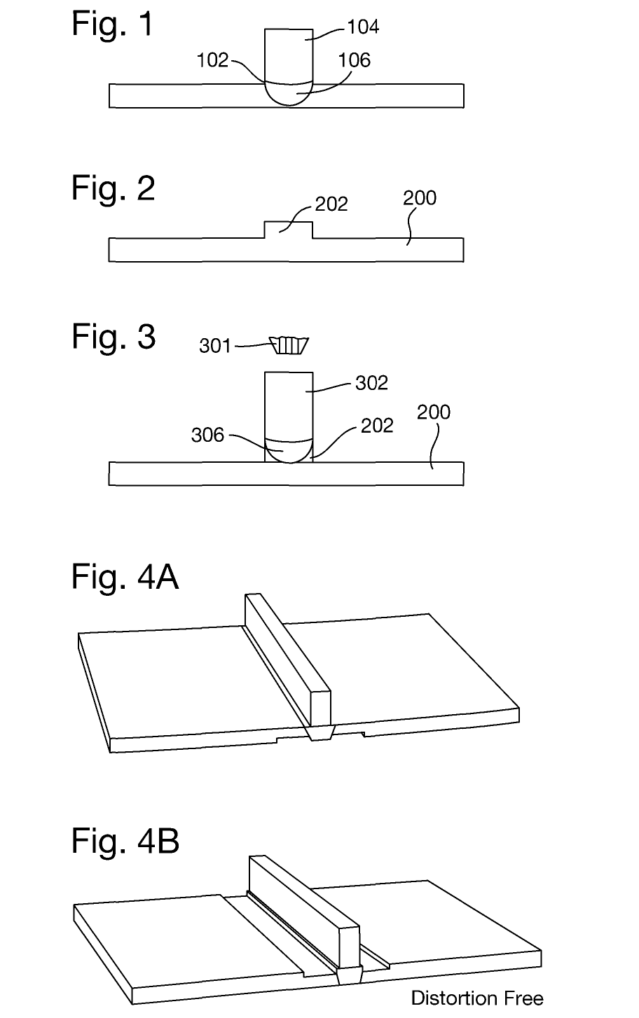

FIG. 1 illustrates schematically a cross section through a work piece 102 and structure layers 104 formed by a conventional ALM process. During deposition of the initial layer(s) the laser beam creates a weld pool 106 on a work piece into which the powder is deposited to form the structure layers, in a similar manner to which a conventional welding process adds filler wire to a weld pool created, but on a much smaller scale. During creation of the weld pool the work piece is subjected to intense localised heating creating steep thermal gradients between the molten material and the cold material further out. If the transverse compressive stresses caused by the very hot expanding material exceed that of the materials yield point then compressive plastic yielding (CPY) will occur in the surrounding material. On cooling and shrinkage high tensile transverse residual stresses across the “weld” will be created and these will be balanced by compressive residual stresses further out. It is these compressive residual stresses that cause buckling distortion when they exceed the critical buckling load (CBL) of the work piece.

The present invention is intended to address at least some of the above mentioned problems. The invention can provide a method of eliminating CPY, and hence residual stress and distortion levels by removing the steep thermal gradients experienced in the plate during the ALM process. By initiating the ALM build on a locally raised section of the parent plate, the area where CPY and shrinkage stresses occur during cooling can be removed as the area thermally effected by the heat source may be constrained within the raised section.

According to first aspect of the present invention there is provided a method of forming a layered structure, the method including:

forming at least one raised area on a work piece, and

forming a structure using an ALM process on the raised area.

The at least one raised area can be of predetermined dimensions. A dimension, e.g. width, of the raised area may correspond to a maximum design dimension of the structure to be formed by the ALM process.

A weld pool caused by deposition of at least one initial layer of the ALM process may be substantially contained/formed within the raised area. Thus, reduced or no distortion of a main body of the work piece on which the raised area is formed may occur.

The at least one raised area may be formed by machining the work piece, or by casting or forging or any cold working process.

The ALM process may comprise a blown powder ALM process or a solid wire arc ALM process.

According to another aspect of the present invention there is provided a structure formed by a method substantially as described herein.

According to yet another aspect of the present invention there is provided apparatus adapted to form a layered structure, the apparatus including:

a work piece having at least one raised area;

an arrangement for holding the work piece in position, and

forming apparatus configured to form a structure on the raised area using an ALM process.

The forming apparatus may include a Nd-YAG CW laser.

According to a further aspect of the present invention there is provided a work piece adapted for use in ALM processing, the work piece having at least one raised area.

Whilst the invention has been described above, it extends to any inventive combination of features set out above in the following description, claims or drawings.

By way of example, a specific embodiment of the invention will now be described by reference to the accompanying drawings, in which:

FIG. 1 illustrates schematically a weld pool formed by a conventional ALM process;

FIG. 2 illustrates an example novel work piece for use in an ALM process;

FIG. 3 illustrates schematically the ALM process involving the work piece of FIG. 2;

FIG. 4A shows a work piece having a structure formed by conventional ALM processing; and

FIG. 4B shows a work pieces having a structure formed according to an embodiment of the present invention.

FIG. 2 shows a work piece 200. The work piece (also known as a “parent plate”) can be formed of any suitable material, typically a strong metal such as titanium, and can have any desired dimensions. The work piece can be held in place for ALM processing by a clamp (not shown) or the like.

The work piece 200 includes a localised raised area 202 on its upper surface. In one embodiment the raised area is formed by conventional machining of the work piece, but it will be understood that it could be formed by other processes, such as casting, forging, any cold working process, etc. The dimensions of the raised area, i.e. its height and width, can vary, depending on the power of the heat source being used. For instance, when carrying out a blown powder ALM process, the dimensions would be smaller than if carrying out ALM by a solid wire arc and is not therefore process limiting.

The width of the raised area will generally match the width of the structure to be formed by the ALM process at that location. The design/dimensions of the structure will be determined prior to performing the ALM process. The ALM apparatus (not shown) is configured in a conventional manner to produce a structure having a particular design and dimensions. The width of the raised area will correspond to a maximum design width of the structure (e.g. the maximum width of the structure wall) to be formed by the ALM layers. The dimensions of the raised section will be determined by factors such as the amount of heat input (in this example, affected by the laser power and the scan speed of the ALM apparatus); the width of the structure to be built; metal type (heat conduction can be important), and whether there is any additional heating or cooling. If the work piece is to have structures formed on it at other locations by ALM processing (e.g. after it or the nozzle of the ALM apparatus has been moved after forming the first ALM structure) then further raised areas may be formed on the work piece, typically at the same time as the first raised area, although it is possible that raised areas could be formed between ALM builds.

FIG. 3 shows the work piece 200 after the nozzle 301 of the ALM apparatus has deposited layers 302 of material on the raised area 202. In one example, linear ALM builds were produced from titanium grade Ti6AI4V powder, on matching grade parent plate, within an argon shielding environment at an oxygen concentration level of ˜10 ppm. However, it will be appreciated that the method described herein is also applicable to any engineering material, metallic or otherwise, that has the ability to be manufactured by ALM. In the example embodiment an Nd-YAG CW laser, with a spot diameter of 3 mm, was used to produce the builds. A beam power of 1200 W was used to produce the first layer of build and reduced to 800 W for subsequent layers. Fully consolidated structures were built by scanning the laser across the substrate at 15 mm/sec, overlapping each individual scan by 1.7 mm, to produce a sample with a wall width of 7 mm. 40 layers of material were deposited whilst incrementing the deposition nozzle 301 by 300 μm after each layer to produce a wall 12 mm in height. Although the embodiments detailed herein relate to ALM processing using a laser, it will be understood that the anti-distortion technique applies to all ALM processes, whether they use a laser or a welding process, for instance.

As can be seen, the weld pool 306 caused by the deposition of the initial layer is substantially contained/formed within the raised area 202, thereby meaning that there is little/no distortion of the main body of the work piece 200. The work piece 200 may be separated from the structure 302 after the ALM processing has been completed.

In one experiment, structures were initially built on a work piece without a raised area. The plate was only clamped along one edge to allow the free edge to freely bend to highlight the levels of distortion induced. Builds were subsequently made on the raised section with positive results. FIGS. 4A and 4B show the levels of distortion of this experiment on work pieces with and without the machined raised section. Without the raised section distortion was seen to be approximately 3 mm whilst distortion was mitigated in the plate built on the raised section.

Improvements provided by embodiments of the present invention over conventional distortion control methods include:
No supplementary external thermal sources applying pre-heating or cooling are required.
No on-line stress engineering tools are required which apply global or local mechanical tensioning methods.
The requirement to carry out post build distortion control processes is mitigated.
The ability to build complex 2D or 3D conformal ALM structures and geometries.

1. A method of forming a layered structure, the method including:
forming at least one raised area on a work piece; and forming a structure on the raised area using an Additive Layer Manufacturing (ALM) process.

2. A method according to claim 1 where the at least one raised area is of predetermined dimensions.

3. A method according to claim 1, wherein a dimension of the raised area corresponds to a maximum design dimension of the structure to be formed by the ALM process.

4. A method according to claim 3, wherein a width of the raised area corresponds to a maximum design width of the structure to be formed by the ALM process.

5. A method according to claim 1, wherein a weld pool caused by deposition of at least one initial layer of the structure by the ALM process is contained/formed within the raised area, thereby reducing or eliminating distortion in a main body of the work piece.

6. A method according to claim 1, wherein the at least one raised area is formed by machining the work piece.

7. A method according to claim 1, wherein the at least one raised area is formed by casting, forging or a cold working process.

8. A method according to claim 1, wherein the ALM process comprises a blown powder ALM process.

9. A method according to claim 1, wherein the ALM process comprises a solid wire arc ALM process.

10. Apparatus to form a layered structure, the apparatus including:
a work piece having at least one raised area;
an arrangement for holding the work piece in position; and forming apparatus configured to form a structure on the raised area using an ALM process.

11. Apparatus according to claim 10, wherein the forming apparatus includes an Nd-YAG CW laser.

12. Apparatus according to claim 10, wherein the forming apparatus includes a welding device.

13. A work piece adapted for use in forming a layered structure using an ALM process, the work piece including at least one raised area.

14. A work piece according to claim 13, wherein the at least one raised area is formed by machining the work piece.

15. A work piece according to claim 13, wherein the at least one raised area is formed by casting, forging or a cold working process.
